(19) United States
(12) Patent Application Publication
(10) Pub. No.: US 2014/0010035 A1
(43) Pub. Date: Jan. 9, 2014

(54) MIXER DRUM DRIVING APPARATUS

(71) Applicant: Yoshimitsu Takahashi, Fukaya-shi (JP)

(72) Inventor: Yoshimitsu Takahashi, Fukaya-shi (JP)

(73) Assignee: KAYABA INDUSTRY CO., LTD., TOKYO (JP)

(21) Appl. No.: 14/006,757

(22) PCT Filed: Mar. 15, 2012
(86) PCT No.: PCT/JP2012/056642

§ 371 Date: Sep. 23, 2013

(30) Foreign Application Priority Data
Mar. 24, 2011 (JP) 2011-065507

(51) Int. Cl. B28C 5/18

(52) U.S. Cl. CPC B28C 5/18
USPC 366/61; 366/54

(57) ABSTRACT

A mixer drum driving apparatus includes a mixer drum carried on a frame of a mixer truck in a frontward tilted condition to be free to rotate, and a drive source configured to drive the mixer drum to rotate. The drive source includes a motor which is disposed in a space between a rear portion of the mixer drum and a rear portion of the frame in order to drive the mixer drum to rotate.

### TECHNICAL FIELD

The present invention relates to a mixer drum driving apparatus that drives a mixer drum of a mixer truck.

### BACKGROUND ART

A concrete mixer truck is a vehicle that transports fresh concrete such as mortar or ready-mixed concrete from a fresh concrete factory to a construction site in a mixer drum that is carried on a frame to be free to rotate.

To prevent the fresh concrete from decreasing in quality and hardening, the mixer drum is rotated normally as the concrete mixer truck transports the fresh concrete such that the fresh concrete is agitated by a plurality of spiral blades disposed in the mixer drum. Further, the concrete mixer truck is configured such that the fresh concrete in the mixer drum can be discharged by rotating the mixer drum in an opposite direction to the normal rotation. When the concrete mixer truck arrives at a concrete pouring site, the mixer drum is rotated in reverse so that the fresh concrete is supplied to a pouring location.

In this type of concrete mixer truck, the mixer drum must be rotated constantly until the fresh concrete is discharged. An engine of the concrete mixer truck is typically used as a drive source of the mixer drum. More specifically, power from the engine is transmitted to a hydraulic pump via a PTO (Power Take Off), whereupon working oil discharged from the hydraulic pump is supplied to a hydraulic motor. The hydraulic motor is driven by the working oil, and the mixer drum is driven to rotate by the rotation of the hydraulic motor.

In a mixer drum driving apparatus that drives a mixer drum using only an engine, an engine rotation speed must be increased when the mixer drum is to be rotated at high speed or the like. When the engine rotation speed is increased in this manner, noise is generated and fuel consumption increases.

JP2007-278430A discloses a mixer drum driving apparatus that drives a mixer drum to rotate by driving an auxiliary hydraulic pump using an electric motor in addition to a main hydraulic pump driven by an engine.

### SUMMARY OF INVENTION

In the mixer drum driving apparatus according to the related art described above, a single hydraulic motor is driven by the hydraulic pump driven by the engine and the auxiliary hydraulic pump driven by the electric motor, and therefore all parts of the driving apparatus, including the main hydraulic pump, the auxiliary hydraulic pump, the electric motor, and an inverter for controlling the motor, must be disposed on the frame between an operator cab of the concrete mixer truck and the mixer drum. As a result, space for carrying the mixer drum on the frame is compressed. When the mixer drum carrying space is compressed in this manner, a fresh concrete carrying capacity decreases, leading to a reduction in transportation efficiency.

Further, in the mixer drum driving apparatus according to the related art, an entire load of the driving apparatus is applied between the operator cab and the mixer drum, and therefore a strength of the frame and a chassis frame must be increased in a disposal position of the driving apparatus. When the strength of the frame and the chassis frame is increased, a vehicle weight (a weight of the vehicle alone) of the concrete mixer truck increases. A maximum carrying capacity of the fresh concrete carried in the mixer drum takes a value obtained by subtracting the vehicle weight from a total vehicle weight, and therefore the maximum fresh concrete carrying capacity decreases as the vehicle weight of the concrete mixer truck increases, leading to a reduction in transportation efficiency.

It is therefore an object of this invention to provide a mixer drum driving apparatus that drives a mixer drum using a motor without causing a reduction in transportation efficiency.

According to an aspect of the present invention, a mixer drum driving apparatus includes a mixer drum carried on a frame of a mixer truck in a frontward tilted condition to be free to rotate, and a drive source configured to drive the mixer drum to rotate. The drive source includes a motor which is disposed in a space between a rear portion of the mixer drum and a rear portion of the frame in order to drive the mixer drum to rotate.

The details as well as other features and advantages of this invention are set forth in the remainder of the specification and are shown in the accompanying drawings.

### BRIEF DESCRIPTION OF DRAWINGS

FIG. 1 is a schematic view showing a configuration of a mixer drum driving apparatus according to a first embodiment of the present invention.

FIG. 2 is a side view of a concrete mixer truck carrying the mixer drum driving apparatus.

FIG. 3 is a back view of a mixer drum carried on a frame of the concrete mixer truck.

FIG. 4 is a perspective view showing a mixer drum driving apparatus according to a modified example of the first embodiment.

FIG. 5 is a schematic view showing a configuration of a mixer drum driving apparatus according to another modified example of the first embodiment.

FIG. 6 is a schematic view showing a configuration of a mixer drum driving apparatus according to a second embodiment of the present invention.

### DESCRIPTION OF EMBODIMENTS

A mixer drum driving apparatus according to a first embodiment of the present invention will be described with reference to the figures.

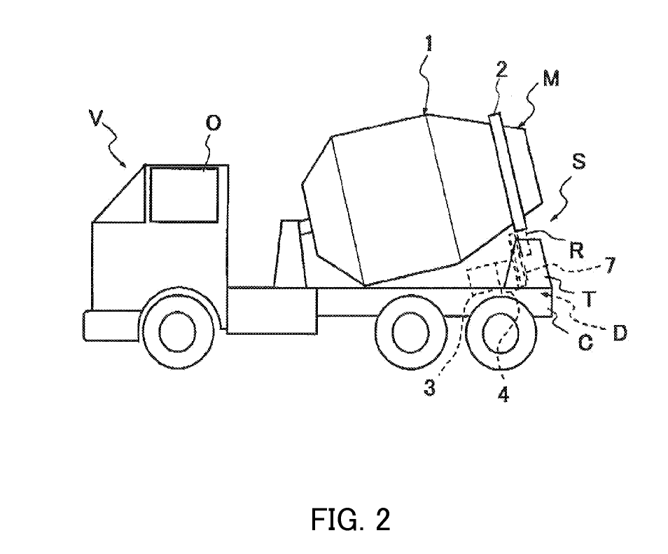

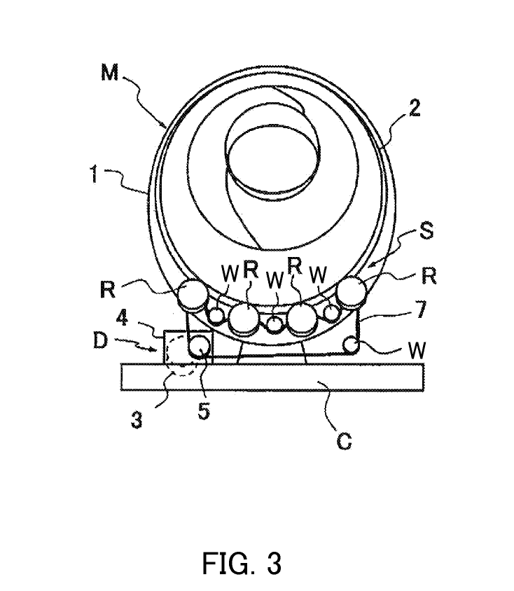

As shown in FIGS. 2 and 3, a concrete mixer truck V includes an operator cab O provided on a vehicle front, and a frame C provided to the rear of the operator cab O. A leg T is attached to a rear portion of the frame C, and four drum rollers R are attached to the leg T to be free to rotate. The drum rollers R are arranged in series in a vehicle width direction so as to support a mixer drum M to be free to rotate from a lower side thereof.

A mixer drum driving apparatus S is an apparatus for driving the mixer drum M. The mixer drum driving apparatus S includes the mixer drum M which is carried on the frame C to be free to rotate, and a drive source D which drives the mixer drum M to rotate. The drive source D that drives the mixer drum M to rotate is disposed on the frame C of the concrete mixer truck V.

The mixer drum M is formed in a closed-end cylinder shape having an open rear end. The mixer drum M is constituted by a drum shell 1 and a roller ring 2 provided on a rear side end outer periphery of the drum shell 1. An axial center portion provided on a front side end of the mixer drum M (the drum shell 1) is supported by a support portion provided on the frame C. The roller ring 2 is supported from below by the four rollers R of the leg T, whereby the mixer drum M is provided on the frame C to be free to rotate. The mixer drum M is disposed on the frame C in a frontward tilted attitude such that the rear side end thereof is lifted upward.

Although not shown in the figures, a plurality of spiral blades are provided on an inner peripheral surface of the drum shell 1. When the mixer drum M is rotated normally by the drive source D, the blades agitate fresh concrete in the mixer drum M while moving the fresh concrete toward the front side. When the fresh concrete is introduced into the mixer drum M, the mixer drum M is rotated normally at a higher speed than during agitation. When the mixer drum M is rotated in reverse by the drive source D, on the other hand, the blades move the fresh concrete in the mixer drum M toward the rear side so that the fresh concrete can be discharged from the mixer drum M.

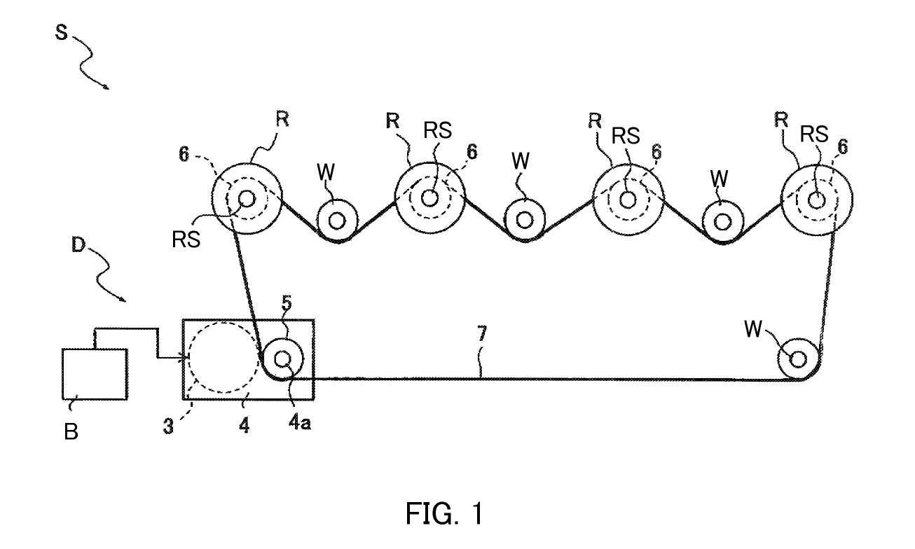

As shown in FIGS. 1 and 3, the drive source D is provided on the frame C in a space between a rear portion of the mixer drum M in the frontward tilted attitude and the rear portion of the frame C. The drive source D includes a motor 3, a reduction gear unit 4 coupled to the motor 3, a sprocket 5 provided on an output shaft 4a of the reduction gear unit 4, a sprocket 6 provided on a rotary shaft RS of each drum roller R, a roller chain 7 wound around the sprockets 5, 6, and a power supply B that supplies power to the motor 3. On the frame C, rearward of a central position in a front-rear direction serving as an advancement direction of the concrete mixer truck V corresponds to the rear portion of the frame C, and respective constituent members constituting the drive source D are provided in the rear portion of the frame C. The drive source D is configured to rotate the motor 3 normally or in reverse such that the mixer drum M is rotated normally or in reverse via the drum rollers R.

To apply a predetermined tension to the roller chain 7, auxiliary sprockets W are provided between the sprocket 5 and a sprocket 6 and between the respective sprockets 6, 6. The four auxiliary sprockets W are attached to the leg T to be free to rotate, similarly to the drum rollers R.

The motor 3 is a rotary electric motor. The motor 3 drives all of the drum rollers R to rotate via the sprockets 5, 6 and the roller chain 7. A belt may be wound around the sprockets 5, 6 instead of the roller chain 7 to transmit power from the motor 3 to the drum rollers R. Further, the drive force of the motor 3 may be transmitted to the drum rollers R using a plurality of gears instead of a power transmission mechanism such as the sprockets 5, 6 and the roller chain 7.

In the drive source D, the motor 3 is driven on the basis of electric power supplied from the power supply B, thereby causing the four drum rollers R to rotate such that the mixer drum M is driven to rotate. All of the drum rollers R are driven to rotate by the motor 3, and therefore, even when slippage occurs between a part of the drum rollers R and the roller ring 2 of the mixer drum M, the mixer drum M can be driven to rotate with stability by the other drum rollers R. It should be noted that only a part of the four drum rollers R may be driven by the motor 3. In this case, the drum rollers R not driven by the motor 3 function as support members for supporting the mixer drum M from below.

The number of disposed drum rollers R is set as desired according to necessity. The number of disposed drum rollers R is set at a number such as two or more, for example, so that the mixer drum M can be supported without being biased to the left or right relative to the vehicle advancement direction. By increasing the number of disposed drum rollers R or driving all of the drum rollers R using the motor 3, a rotation defect in the mixer drum M due to spinning of the drum rollers R can be suppressed.

In the drive source D, a reduction ratio between the motor 3 and the sprocket 5 is adjusted using the reduction gear unit 4. However, the reduction ratio can also be adjusted in accordance with the number of teeth of the sprockets 5, 6, and therefore, when the reduction ratio is set using the sprockets 5, 6, the reduction gear unit 4 need not be provided. Further, when a torque of the motor 3 is sufficiently large, a speed reduction mechanism need not be provided between the motor 3 and the drum rollers R.

In the mixer drum driving apparatus S according to the first embodiment, the motor 3 constituting the drive source D that drives the mixer drum M is provided in the rear portion of the frame C, or in other words in the space between the rear portion of the mixer drum M in the frontward tilted attitude and the rear portion of the frame C. The drive source D is not provided between the operator cab O of the concrete mixer truck V and the mixer drum M, and therefore space for carrying the mixer drum M can be secured on the frame C. Hence, a capacity of the mixer drum M is not compressed, and therefore a sufficient fresh concrete carrying capacity can be secured. As a result, a reduction in a fresh concrete transportation amount can be prevented, and the mixer drum M can be driven by the motor 3 without causing a reduction in transportation efficiency. Further, since the transportation efficiency is not reduced, a fuel consumption of the concrete mixer truck V can be reduced.

In the mixer drum driving apparatus S, the mixer drum M is rotated only by the motor 3 of the drive source D, and therefore a main hydraulic pump driven by an engine, an auxiliary hydraulic pump driven by a motor, and so on, such as those of the mixer drum driving apparatus according to the related art, are not provided. The mixer drum driving apparatus S can therefore be reduced in weight in comparison with the mixer drum driving apparatus according to the related art. Accordingly, there is no need to increase a strength of a chassis and the frame C, and therefore a part of the chassis and the frame C in which the mixer drum driving apparatus S is disposed can be reduced in weight.

In the mixer drum driving apparatus S, the mixer drum M is driven to rotate by rotating the drum rollers R using the motor 3, and therefore an output torque required of the motor 3 is smaller than that of a case in which a front end shaft of the mixer drum M is driven to rotate, as in the mixer drum driving apparatus according to the related art. As a result, the motor 3 can be reduced in both size and weight.

In the mixer drum driving apparatus S, the mixer drum M is rotated using the plurality of drum rollers R, and therefore unevenness is unlikely to occur in a rotation speed of the mixer drum M. It should be noted that in this embodiment, the mixer drum M is driven to rotate by rotating the drum rollers R that contact the roller ring 2, but instead, the mixer drum M may be driven to rotate by providing a gear or gears disposed around the outer peripheral surface of the mixer drum M in the circumferential direction and transmitting the drive force of the motor 3 to the gear.

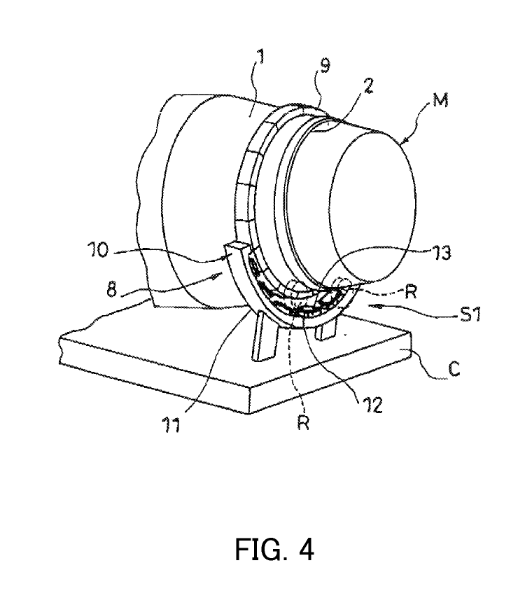

Referring to FIG. 4, a mixer drum driving apparatus Si according to a modified example of the first embodiment will be described.

In the mixer drum driving apparatus S according to the first embodiment, the motor 3 is a rotary electric motor, whereas in the mixer drum driving apparatus S1 according to the modified example shown in FIG. 4, a motor 8 is a linear motor. The motor 8 serves as the drive source that drives the mixer drum M to rotate. The motor 8 includes a plurality of moving magnets 9 (magnetic field means) attached to the outer peripheral surface of the drum shell 1 of the mixer drum M so that different magnetic poles appear alternately in the circumferential direction, and an armature 10 provided on the frame C to oppose the moving magnets 9. The armature 10 of the motor 8 is disposed on the frame C in the space between the rear portion of the mixer drum M in the frontward tilted attitude and the rear portion of the frame C.

In the mixer drum driving apparatus S1 according to the modified example shown in FIG. 4, the motor 3, reduction gear unit 4, sprockets 5, 6, and roller chain 7 of the first embodiment are not provided. Only two drum rollers R are provided so that the mixer drum M can be supported without being biased to the left or right relative to the vehicle advancement direction, and the two drum rollers R are attached to the leg T, not shown in the figure. All other structures of the concrete mixer truck V are identical to the first embodiment, and therefore detailed description thereof has been omitted.

The armature 10 includes an arc-shaped frame 11 disposed on the rear portion of the frame C, a plurality of fixed magnets 12 provided on an upper surface of the frame 11 in alignment with the outer periphery of the mixer drum M, and coils 13 wound respectively around the fixed magnets 12. The fixed magnets 12 are provided to oppose the moving magnets 9 provided on the outer periphery of the mixer drum M. The coils 13 are connected to the power supply B via an inverter. The mixer drum M is driven to rotate by supplying power to the coils 13 so that the moving magnets 9 opposing the fixed magnets 12 are attracted and repelled. The motor 8 thus constitutes a linear motor that rotates the mixer drum M normally and in reverse.

The motor 8 may be provided further toward a front side of the vehicle than the leg T (not shown) or further toward a rear side. Moreover, the moving magnets 9 may be attached to a front side end or a rear side end of the roller ring 2, the two drum rollers R may be disposed at a remove from each other in the vehicle width direction, and the armature 10 may be provided between the drum rollers R.

In the mixer drum driving apparatus S1, the motor 8 constituting the drive source that drives the mixer drum M is provided in the rear portion of the frame C, and the armature 10 of the motor 8 is provided on the frame C in the space between the rear portion of the mixer drum M in the frontward tilted attitude and the rear portion of the frame C. Since the drive source is not provided between the operator cab O of the concrete mixer truck V and the mixer drum M, space for carrying the mixer drum M can be secured on the frame C. Hence, the capacity of the mixer drum M is not compressed, and therefore a sufficient fresh concrete carrying capacity can be secured. As a result, a reduction in the fresh concrete transportation amount can be prevented, and the mixer drum M can be driven by the motor 3 without causing a reduction in transportation efficiency. Further, since the transportation efficiency is not reduced, the fuel consumption of the concrete mixer truck V can be reduced. Moreover, the part of the chassis and the frame C in which the mixer drum driving apparatus S is disposed can be reduced in weight in comparison with the related art.

Furthermore, with the motor 8, the mixer drum M is driven to rotate without contact, and therefore wear on a power transmission mechanism and so on does not occur. As a result, a lifespan of the mixer drum driving apparatus S1 can be lengthened.

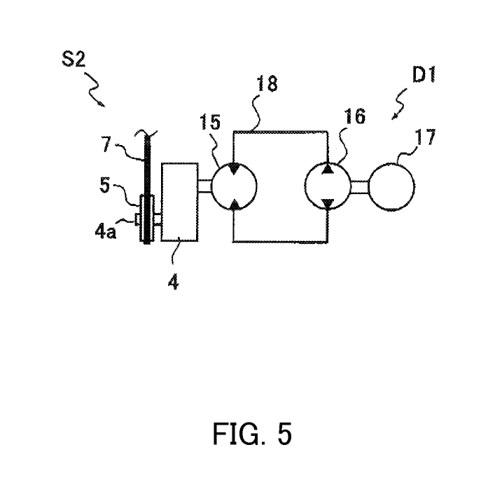

Referring to FIG. 5, a mixer drum driving apparatus S2 according to another modified example of the first embodiment will be described.

In the mixer drum driving apparatus S2 according to the modified example shown in FIG. 5, a drive source D1 includes a hydraulic motor 15 that drives the drum rollers R to rotate, a hydraulic pump 16 that supplies working oil to the hydraulic motor 15, and a motor 17 that drives the hydraulic pump 16. Power from the hydraulic motor 15 is transmitted to the drum rollers R via the reduction gear unit 4, the sprockets 5, 6, and the roller chain 7. The mixer drum driving apparatus S2 differs from the mixer drum driving apparatus S according to the first embodiment in that power from the motor 17 is transmitted to the drum rollers R via the hydraulic pump 16 and the hydraulic motor 15. The drive source D1 of the mixer drum driving apparatus S2 is provided on the frame C in the space between the rear portion of the mixer drum M in the frontward tilted attitude and the rear portion of the frame C.

The hydraulic pump 16 and the hydraulic motor 15 are connected by a loop-shaped pipe line 18. A discharge direction of the working oil from the hydraulic pump 16 is switched by rotating the motor 17 either normally or in reverse. By switching the discharge direction of the working oil from the hydraulic pump 16, the hydraulic motor 15 is rotated either normally or in reverse, and as a result, the mixer drum M is rotated either normally or in reverse.

In the mixer drum driving apparatus S2, the drive source D1 is provided in the rear portion of the frame C, or in other words on the frame C in the space between the rear portion of the mixer drum M in the frontward tilted attitude and the rear portion of the frame C. The drive source D1 is not provided between the operator cab O of the concrete mixer truck V and the mixer drum M, and therefore space for carrying the mixer drum M can be secured on the frame C. Hence, the capacity of the mixer drum M is not compressed, and therefore a sufficient fresh concrete carrying capacity can be secured. As a result, a reduction in the fresh concrete transportation amount can be prevented, and the mixer drum M can be driven by the motor 3 without causing a reduction in transportation efficiency. Since the transportation efficiency is not reduced, the fuel consumption of the concrete mixer truck V can be reduced. Moreover, the part of the chassis and the frame C in which the mixer drum driving apparatus S is disposed can be reduced in weight in comparison with the related art.

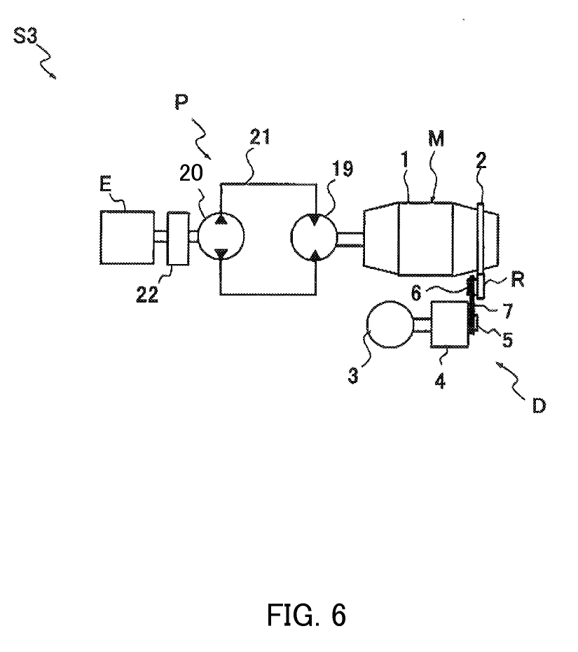

Referring to FIG. 6, a mixer drum driving apparatus S3 according to a second embodiment of the present invention will be described.

The mixer drum driving apparatus S3 according to the second embodiment includes the same drive source D as the mixer drum driving apparatus S according to the first embodiment, and a hydraulic system P that drives the mixer drum M to rotate independently of the motor 3 of the drive source D.

The hydraulic system P includes a second hydraulic motor 19 coupled to the axial center portion provided on the front side end of the mixer drum M, and a second hydraulic pump 20 that is driven to rotate by an engine E of the concrete mixer truck V to supply working oil to the second hydraulic motor 19. The second hydraulic motor 19 and the second hydraulic pump 20 are connected by a loop-shaped pipe line 21. The second hydraulic pump 20 is connected to the engine E via a PTO 22 that draws power from the engine E to the outside.

The second hydraulic pump 20 is a bidirectional discharge type hydraulic pump. By switching a discharge direction of the working oil supplied to the second hydraulic motor 19 from the second hydraulic pump 20, the mixer drum M is rotated either normally or in reverse. The second hydraulic motor 19, the second hydraulic pump 20, and so on constituting the hydraulic system P are disposed on the frame C between the operator cab O of the concrete mixer truck V and the mixer drum M.

In the mixer drum driving apparatus S3 according to the second embodiment, two systems, namely the hydraulic system P and the drive source D, are used as systems for driving the mixer drum M to rotate, and therefore the mixer drum M can be driven to rotate even when a problem occurs in one of the systems.

The motor 3 of the mixer drum driving apparatus S3 is a motor generator, and therefore functions as a power generator that generates electric power as the mixer drum M rotates when the mixer drum M is rotated by the hydraulic system P. When the mixer drum M is rotated on the basis of the drive force from the second hydraulic motor 19, the motor 3 generates power. The motor 3 and the power supply B are electrically connected such that the power generated by the motor 3 is supplied to the power supply B. As a result, the power supply B is charged.

In the mixer drum driving apparatus S3, the hydraulic system P is disposed on the frame C between the operator cab O of the concrete mixer truck V and the mixer drum M, while the drive source D is disposed in the rear portion of the frame C. Hence, the hydraulic system P and the drive source D are provided discretely on the frame C, and therefore a load of the mixer drum driving apparatus S3 is not concentrated on the part of the frame C between the operator cab O and the mixer drum M. The strength of the frame C and a chassis frame of the concrete mixer truck V between the operator cab O and the mixer drum M does not therefore have to be increased above that of the related art, and as a result, the vehicle weight of the concrete mixer truck V can be reduced and a maximum fresh concrete carrying capacity can be increased. Since a sufficient fresh concrete carrying capacity can be secured, a reduction in the fresh concrete transportation amount can be prevented, and therefore the mixer drum M can be driven by the motor 3 without causing a reduction in transportation efficiency. Furthermore, since the transportation efficiency is not reduced, the fuel consumption of the concrete mixer truck V can be reduced.

In the mixer drum driving apparatus S3, when a charged capacity of the power supply B is low, the power supply B can be charged using the motor 3 by driving the mixer drum M to rotate using the hydraulic system P. Therefore, a situation in which the mixer drum M stops rotating while transporting fresh concrete can be prevented. After the power supply B has been sufficiently charged, the mixer drum M can be driven to rotate using the motor 3. By charging the power supply B using the motor 3 in this manner, the power supply B does not have to be charged frequently using a commercial power supply.

It should be noted that the hydraulic system P described above may also be applied to the mixer drum driving apparatuses 51, S2 described as modified examples of the first embodiment. Likewise in the mixer drum driving apparatuses S1, S2, the power supply B can be charged by configuring the motors 8, 17 to have an additional function as a power generator.

Although the invention has been described above with reference to certain embodiments, the invention is not limited to the embodiments described above. Modifications and variations of the embodiments described above will occur to those skilled in the art, within the scope of the claims.

The present application claims priority based on JP2011-065507, filed with the Japan Patent Office on Mar. 24, 2011, the entire contents of which are incorporated into this specification by reference.

1. A mixer drum driving apparatus comprising:
a mixer drum carried on a frame of a mixer truck in a frontward tilted condition to be free to rotate; and
a drive source configured to drive the mixer drum to rotate,
wherein the drive source comprises a motor which is disposed in a space between a rear portion of the mixer drum and a rear portion of the frame in order to drive the mixer drum to rotate.

2. The mixer drum driving apparatus as defined in claim 1, wherein the drive source further comprises a drum roller which contacts from below a roller ring provided on a rear outer periphery of the mixer drum, and
the motor is configured to drive the mixer drum to rotate by rotating the drum roller.

3. The mixer drum driving apparatus as defined in claim 2, wherein the drum roller is provided in a plurality, and
the motor is configured to drive all of the drum rollers to rotate.

4. The mixer drum driving apparatus as defined in claim 2, wherein the drive source further comprises:
a hydraulic motor configured to drive the drum roller to rotate; and
a hydraulic pump configured to supply working oil to the hydraulic motor, and
the motor is configured to drive the hydraulic pump.

5. The mixer drum driving apparatus as defined in claim 1, wherein the motor is a linear motor which comprises
a magnet which is provided on a rear outer periphery of the mixer drum and has different magnetic poles arranged alternately in a circumferential direction, and
an armature provided on the frame to oppose the magnet.

6. The mixer drum driving apparatus as defined in claim 1, further comprising:
a hydraulic motor coupled to the mixer drum to be capable of driving the mixer drum to rotate; and
a hydraulic pump which is driven by an engine of the mixer truck to supply working oil to the hydraulic motor,
wherein the motor is driven by a rotation of the mixer drum so as to generate electric power when the mixer drum is driven to rotate by the hydraulic motor.
